(19) United States
(12) Patent Application Publication
(10) Pub. No.: US 2012/0289247 A1
(43) Pub. Date: Nov. 15, 2012

(54) Radio Node, Positioning Node, and Methods Therein

(75) Inventors: Iana Siomina, Solna (SE); Muhammad Kazmi, Bromma (SE); Tao Cui, Upplands Vasby (SE)

(73) Assignee: Telefonaktiebolaget L M Ericsson (publ), Stockholm (SE)

(21) Appl. No.: 13/497,187

(22) PCT Filed: Feb. 14, 2012
(86) PCT No.: PCT/SE2012/050148

§ 371 Date: Mar. 20, 2012

Related U.S. Application Data
(60) Provisional application No. 61/484,971, filed on May 11, 2011.

(51) Int. Cl. H04W 24/00

(52) U.S. Cl. 455/456.1

(57) ABSTRACT

Embodiments herein relate to a method in a radio node (10,12) for enabling timing measurement for positioning of a user equipment (10) served in a cell (11) controlled by a radio network node (12). The radio node configures the uplink and/or downlink signal for use by the user equipment (10) to perform a measurement or for a purpose other than a positioning measurement, The radio node (10,12) provides a positioning node (17) with an indication that the uplink and/or the downlink signal are configured for use by the user equipment (10). Thereby is the positioning node (17) enabled to use timing measurements of the uplink and/or downlink signal for positioning the user equipment (10).

### TECHNICAL FIELD

Embodiments herein relate to a radio node, a positioning node and methods therein. In particular, embodiments herein relate to enable timing measurement for positioning of a user equipment served in a cell.

### BACKGROUND

In today's radio communications networks a number of different technologies are used, such as Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. A radio communications network comprises radio network nodes such as radio base stations, also called eNodeB, providing radio coverage over at least one respective geographical area forming a cell. The cell definition may also incorporate frequency bands used for transmissions, which means that two different cells may cover the same geographical area but using different frequency bands. User equipments (UE) are served in the cells by the respective radio base station and are communicating with respective radio base station. The user equipments transmit data over an air or radio interface to the radio base stations in Uplink (UL) transmissions and the radio base stations transmit data over an air or radio interface to the user equipments in Downlink (DL) transmissions.

In 3rd Generation Partnership Project (3GPP) systems, e.g. LTE, a number of timing measurements are standardized, such as: user equipment Receiving (Rx)−Transmitting (Tx) time difference; eNodeB Rx−Tx time difference; Timing Advance (TA); Reference Signal Time Difference (RSTD); user equipment Global Navigation Satellite System (GNSS) Timing of Cell Frames for user equipment positioning; and Evolved-Universal Terrestrial Radio Access Network (E-UTRAN) GNSS Timing of Cell Frames for user equipment positioning. The timing measurements UE Rx−Tx time difference, eNodeB Rx−Tx time difference and Timing Advance (TA), are timing cell range measurements, for simplicity, also called herein timing measurements, since the timing measurements reflect the cell range. These timing measurements are similar to round trip time (RTT) measurements in earlier systems. Furthermore, these timing measurements are based on both DL and UL transmissions. In particular, for UE Rx−Tx time difference, the user equipment measures the difference between the time of the received DL transmission that occurs after the user equipment UL transmission and the time of the UL transmission. For eNodeB Rx−Tx time difference, the eNodeB measures the difference between the time of the received UL transmission that occurs after the eNodeB DL transmission and the time of the DL transmission.

The UE Rx−Tx time difference is defined as T_{UE-RX}−T_{UE-TX},

where
T_{UE-RX} is the user equipment received timing of downlink radio frame #i from the serving cell, defined by the first detected path in time.
T_{UE-TX} is the user equipment transmit timing of uplink radio frame #i. The reference point for the UE Rx−Tx time difference measurement shall be the user equipment antenna connector. This is applicable for Radio Resource Control (RRC)_CONNECTED intra-frequency.

The eNodeB Rx−Tx time difference is defined as T_{eNB-RX}−T_{eNB-TX},

where:
T_{eNB-RX} is the eNodeB received timing of uplink radio frame #i, defined by the first detected path in time. The reference point for T_{eNB-Rx} shall be the Rx antenna connector and eNb is an abbreviation of eNobeB.
T_{eNB-TX} is the eNodeB transmit timing of downlink radio frame #i. The reference point for T_{eNB-TX} shall be the Tx antenna connector.
Timing advance (T_{ADV}) type 1 is defined as the time difference T_{ADV}=(eNodeB Rx−Tx time difference)+(UE Rx−Tx time difference),
where the eNodeB Rx−Tx time difference corresponds to the same user equipment that reports the UE Rx−Tx time difference.
Timing advance (T_{ADV}) type 2 is defined as the time difference T_{ADV}=(eNodeB Rx−Tx time difference),
where the eNodeB Rx−Tx time difference corresponds to a received uplink radio frame containing Physical Random Access Channel (PRACH) from the respective user equipment

Timing measurements may be used for positioning, e.g. with Enhanced Cell Identification (E-CID), Adaptive Enhanced Cell ID (AECID), pattern matching, or hybrid positioning methods, for network planning, for Self-Organising Networks (SON), for enhanced Inter Cell Interference Coordination (eICIC) and for Heterogeneous Networks (HetNet), e.g. for optimizing the cell ranges of different cell types, and also for configuration of handover parameters, time coordinated scheduling, etc. Timing advance may also be used to control the timing adjustment of user equipment UL transmissions. The adjustment is transmitted to the user equipment in the timing advance command. In LTE, for user equipments not supporting LTE Positioning Protocol (LPP), the user equipment timing adjustment is based on TA type 2 only.

In addition, in e.g. LTE there are timing measurements which are implementation dependent and not explicitly standardized; one such timing measurement is a one-way propagation delay: This one-way propagation delay is measured by eNodeB for estimation of timing advanced to be signalled to the user equipment.

### Timing Measurement Procedures

UE Rx−Tx time difference measurements may be reported by the user equipment to eNodeB or a positioning node and may be requested by the respective nodes, but either both or none of the two reporting possibilities are possible with the current standard. eNodeB Rx−Tx time difference measurements may be reported e.g. to the positioning node and may also be requested by the positioning node. TA measurements require the knowledge of at least eNodeB Rx−Tx time difference and thus can only be performed by eNodeBs.

For positioning, non-contention based random access procedure may be used for eNodeB Rx−Tx and is described in the following manner
Step 0: Random Access Preamble assignment is signalled to the user equipment via dedicated signalling in DL, e.g. Packet Data Control Channel (PDCCH): eNodeB assigns to user equipment a non-contention Random Access Preamble, i.e. a Random Access Preamble not within a set indicated in broadcast signalling).
Step 1: The Random Access Preamble is signalled on Random Access Channel (RACH) in UL: Thus, the user equipment transmits the assigned non-contention Random Access Preamble.
Step 2: Random Access Response is signalled on Downlink Shared Channel (DL-SCH) for one or multiple user equipments in one DL-SCH message conveying at least: Timing Alignment information for UL; Timing Alignment information for DL data arrival; RA-preamble identifier.

When Carrier Aggregation (CA) is configured, the Random Access Preamble assignment via PDCCH of step 0, step 1 and 2 of the non-contention based random access procedure occur on the Primary Cell (PCell).

The DL and UL signals used by the user equipment for performing the UE Rx−Tx time difference measurement are not explicitly specified. However typically the DL measurements may be performed by the user equipment, e.g., on Cell specific Reference Signals (CRS), and UL measurements may be performed by the user equipment, e.g., on Sounding Referece Signals (SRS) or Dedicated Reference Signals (DRS) or any other suitable signal. In all cases, however, the Reference Signals (RS) or the signals/channels have to be known to the user equipment. Common cell SRS configuration is provided in System Information Block (SIB), broadcasted in SIB2, and may be provided for the PCell and a secondary cell (SCell). Dedicated SRS configuration has to be configured for each user equipment; the configuration is done by the eNodeB.

### Positioning

The possibility of identifying geographical location, referred to herein as position, of the user equipment in the network has enabled a large variety of commercial and non-commercial services, e.g., navigation assistance, social networking, location-aware advertising, emergency calls, etc. Different services may have different positioning accuracy requirements imposed by the application. In addition, some regulatory requirements on the positioning accuracy for basic emergency services exist in some countries, i.e. Federal Communications Commission (FCC) E911 in the United States of America.

In many environments, the position can be accurately estimated by using positioning methods based on Global Positioning System (GPS). Nowadays networks have also often a possibility to assist user equipments in order to improve the terminal receiver sensitivity and GPS start-up performance e.g. Assisted-GPS positioning (A-GPS). GPS or A-GPS receivers, however, may be not necessarily available in all user equipments. Furthermore, GPS is known to often fail in indoor environments and urban canyons. A complementary terrestrial positioning method, called Observed Time Difference of Arrival (OTDOA), has therefore been standardized by 3GPP. In addition to OTDOA, the LTE standard also specifies methods, procedures and signalling support for Enhanced Cell ID (E-CID) and Advanced-GNSS (A-GNSS). Uplink Time Difference of Arrival (UTDOA) is also being standardized for LTE.

### Positioning Architecture in LTE

In LTE positioning architecture, the three key network elements are the Location Services (LCS) Client, the LCS target and the LCS Server. The LCS Server is a physical or logical entity managing positioning for a LCS target device by collecting measurements and other location information, assisting the user equipment in measurements when necessary, and estimating the LCS target location. A LCS Client is a software and/or hardware entity that interacts with a LCS Server for the purpose of obtaining location information for one or more LCS targets, i.e. the entities being positioned. LCS Clients may reside in the LCS targets themselves. An LCS Client sends a request to LCS Server to obtain location information, and LCS Server processes and serves the received requests and sends the positioning result and optionally a velocity estimate to the LCS Client. A positioning request can be originated from the user equipment or the network node.

Position calculation may be conducted, for example, by a positioning server, e.g. Evolved Serving Mobile Location Centre (E-SMLC) or a Secure User Plane Location (SUPL) location platform (SLP) in LTE, or a user equipment. The former approach corresponds to the user equipment-assisted positioning mode, whilst the latter corresponds to the user equipment-based positioning mode.

Two positioning protocols operating via the radio network exist in 3GPP LTE, LPP and LPP annex (LPPa). The LPP is a point-to-point protocol between a LCS Server and a LCS target device, used in order to position the LCS target device. LPP may be used both in the user plane, i.e. carrying user data traffic, and control plane, i.e. carrying control information, and multiple LPP procedures are allowed in series and/or in parallel thereby reducing latency. LPPa is a protocol between eNodeB and LCS Server specified only for control-plane positioning procedures, although it still can assist user-plane positioning by querying eNodeBs for information and eNodeB measurements. SUPL protocol is used as a transport for LPP in the user plane. LPP has also a possibility to convey LPP extension messages inside LPP messages, e.g., currently Open Mobile Alliance (OMA) LPP extensions (LPPe) are being specified to allow, e.g., for operator- or manufacturer-specific assistance data or assistance data that cannot be provided with LPP or to support other position reporting formats or new positioning methods. LPPe may also be embedded into messages of other positioning protocol, which is not necessarily LPP.

Positioning Methods and Timing Measurements that May be Used for Positioning

To meet Location Based Services (LBS) demands, the LTE network will deploy a range of complementing methods characterized by different performance in different environments. Depending on where the timing measurements are conducted and the final position is calculated, the methods may be user equipment-based, user equipment-assisted or network-based, each with own advantages. The following methods are available in the LTE standard for both the control plane and the user plane: Cell ID (CID); user equipment-assisted and network-based E-CID, including network-based Angle of Arrival (AoA); user equipment-based and user equipment-assisted A-GNSS, including A-GPS); and user equipment-assisted Observed Time Difference of Arrival (OTDOA).

Hybrid positioning, fingerprinting positioning/pattern matching and Adaptive E-CID (AECID) do not require additional standardization and are therefore also possible with LTE. Furthermore, there may also be user equipment-based versions of the methods above, e.g. user equipment-based GNSS, e.g. using GPS, or user equipment-based OTDOA, etc. There may also be some alternative positioning methods such as proximity based location. UTDOA may also be standardized in a later LTE release. Similar methods, which may have different names, also exist in other Radio Access Technologies (RAT), e.g. Code division multiple access (CDMA), WCDMA or GSM.

E-CID positioning exploit the advantage of low-complexity and fast positioning with CID which exploits the network knowledge of geographical areas associated with cell IDs, but enhances positioning further with more timing measurement types. With E-CID, the following sources of position information are involved: Cell Identification (CID) and the corresponding geographical description of the serving cell, timing measurement of the serving cell, CIDs and the corresponding signal measurements of the cells, AoA measurements. The following E-CID timing measurements from the user equipment may be reported for E-CID via LPP to the positioning node in LTE: Reference Signal Received Power (RSRP) and corresponding CIDs, e.g. up to 32 cells in LTE, including the serving cell; Reference Signal Received Quality (RSRQ) and corresponding CIDs, e.g. up to 32 cells in LTE, including the serving cell; and UE Rx−Tx time difference for the serving cell. Any of these three user equipment timing measurement types may be requested by the positioning node from the user equipment via LPP. Together with the result for the timing measurements in the cell, the user equipment also reports the cell Physical Cell Identity (PCI) and carrier frequency and may also report Cell Global Identity (CGI) and Sub Frame Number (SFN).

The user equipment may also report timing measurements for E-CID over Radio Resource Control (RRC) to the eNodeB, which may then be reported by eNodeB to the positioning node. E.g. RSRP and corresponding CIDs, RSRQ and corresponding CIDs, ans UE Rx−Tx time difference for the serving cell.

In addition to the timing measurements above, the user equipment may also report the SFN of the cell wherein the user equipment performed the timing measurements and other measurements e.g. inter-RAT measurements, or information e.g. Closed Subscriber Group (CSG) indicator indicating whether the user equipment is a member of the CSG of the measured cell. The E-UTRAN timing measurements available for E-CID transmitted from eNodeB via LPPa to the positioning node are: RSRP and RSRQ and corresponding CIDs, up to 32 cells in LTE, including the serving cell; Timing Advance (TA) Type 1 i.e. eNodeB Rx−Tx time difference+UE Rx−Tx time difference for the serving cell; TA Type 2 i.e. eNodeB Rx−Tx time difference for the serving cell; and UL AoA for the serving cell. Any of the four timing measurement types above can be requested by the positioning node from eNodeB via LPPa. As stated, UE Rx−Tx time difference and TA Type 2 are defined only for the serving cell and thus also TA Type 1 is also defined only for the serving cell, or PCell in a CA network.

The timing measurements for E-CID are not restricted to be performed on any specific channel or signal, neither for DL nor for UL. The DL Rx measurements, however, are more likely to be performed on CRS signals. For the UL Tx, the user equipment may use any of UL transmissions, e.g., the definition of TA Type 2 suggests that PRACH transmissions may be used. The accuracy tests for UE Rx−Tx time difference measurements are specified assuming configured SRS transmissions, but SRS transmissions are expected to give better performance at least because they are transmitted periodically and may be more dense. Timing measurements standardized for E-CID may also be used for other positioning measurement, e.g., AECID, Radio Frequency (RF) pattern matching or fingerprinting and hybrid positioning.

### UE Rx−Tx Timing Measurements for Non-Serving Cells or Secondary Cells (SCells)

That the user equipment may report intra-frequency and inter-frequency UE Rx−Tx timing measurements, i.e., the measurements being performed in at least one cell which is not a serving cell and not a PCell, has been disclosed as well as reporting criteria in the user equipment for these timing measurements.

However, the prior art solutions provide an insufficient signaling support even for the standardized single-cell UE Rx−Tx timing measurements triggered by the positioning node in LTE, e.g. the user equipment may fail to perform the requested timing measurements due to that the signals are not configured by eNodeB which is not aware of that the user equipment was requested to perform the measurements, and it may not be possible to meet the requirements without ensuring that the necessary radio signals that have to be measured are configured. A similar problem may occur with other timing measurements, e.g. timing measurements that involve at least transmissions in UL, e.g., TA, user equipment RTT, propagation delay or similar.

Timing measurements, such as UE Rx−Tx time difference measurements, in the current specification has to rely on the configured UL transmissions and the configured DL transmissions, which may lead to poor measurement quality or even measurement failure in the worst case, e.g., when the DL or UL signals are not available or available sparsely in time or over a small bandwidth, for example, when SRS are not configured or CRS are not transmitted due to power saving or emergency.

### SUMMARY

An object of embodiments herein is to enable reliable positioning of a user equipment in an efficiently manner.

According to an aspect of embodiments herein the object is achieved by a method in a radio node for enabling timing measurement for positioning of a user equipment served in a cell controlled by a radio network node. The radio node configures an uplink and/or a downlink signal for use by the user equipment to perform a measurement or for a purpose other than a positioning measurement, The radio node provides a positioning node with an indication that the uplink and/or the downlink signal are configured for use by the user equipment. The positioning node is thereby enabled to use timing measurements of the uplink and/or downlink signal for positioning the user equipment.

According to another aspect of embodiments herein the object is achieved by a method in the positioning node for enabling timing measurement for positioning of the user equipment served in the cell controlled by the radio network node. The positioning node receives, from the user equipment or the radio network node, information that the user equipment in the cell is configured with an uplink and/or a downlink signal for use by the user equipment. The positioning node then requests the user equipment to perform a timing measurement for positioning using the configured uplink and/or downlink signal.

According to yet another aspect of embodiments herein the object is achieved by a radio node for enabling timing measurement for positioning of the user equipment served in the cell controlled by the radio network node. The radio node comprises a configuring circuit adapted to configure an uplink and/or a downlink signal for use by the user equipment to perform a measurement or for a purpose other than a positioning measurement. The radio node further comprises a providing circuit configured to provide the positioning node with an indication that the uplink and/or the downlink signal are configured for use by the user equipment. The positioning node is thereby enabled to use timing measurements of the uplink and/or downlink signal for positioning the user equipment.

According to still another aspect of embodiments herein the object is achieved by a positioning node for enabling timing measurement for positioning of the user equipment served in the cell controlled by the radio network node. The positioning node comprises a receiving circuit configured to receive, from the user equipment or the radio network node, information that the user equipment in the cell is configured with an uplink and/or a downlink signal for use by the user equipment. The positioning node further comprises a requesting circuit configured to request the user equipment to perform a timing measurement for positioning using the configured uplink and/or downlink signal.

Embodiments herein relate to enable the positioning node to use already configured signals to perform timing measurements for positioning of the user equipment.

### BRIEF DESCRIPTION OF THE DRAWINGS

Embodiments will now be described in more detail in relation to the enclosed drawings, in which:

FIG. 1 is a schematic overview of a radio communications network according to embodiments herein,

FIG. 2 is a combined flowchart and signalling scheme according to embodiments herein,

FIG. 3 is a schematic flowchart depicting a method in a radio node according to embodiments herein,

FIG. 4 is a block diagram depicting the radio node according to embodiments herein,

FIG. 5 is a schematic flowchart depicting a method in a positioning node according to embodiments herein,

FIG. 6 is a block diagram depicting the positioning node according to embodiments herein, and

FIG. 7 is a block diagram depicting a radio communications network.

### DETAILED DESCRIPTION

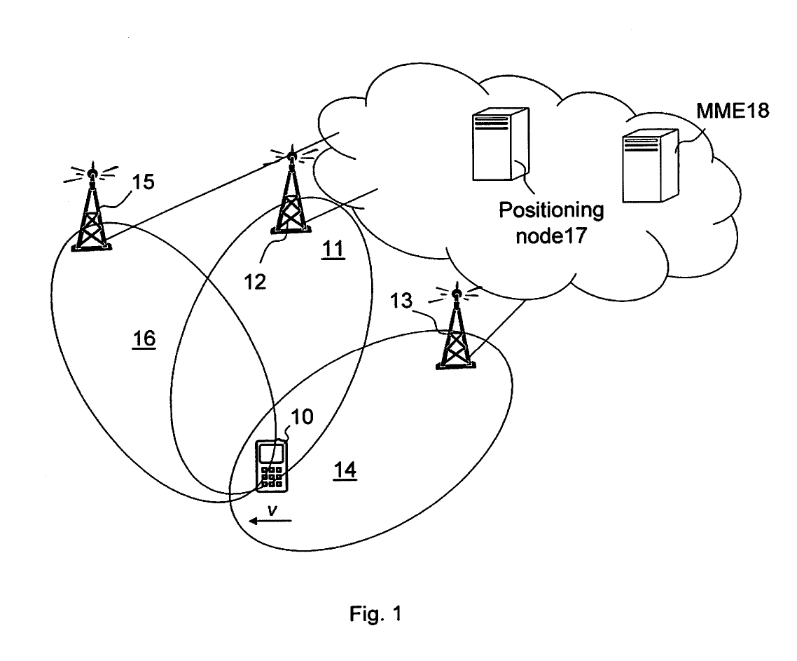

FIG. 1 is a schematic overview of a radio communications network such as a LTE, LTE-Advanced, WCDMA, GSM/EDGE, WiMax or UMB network just to mention a few possible implementation. The radio communications network comprises a radio network node 12, such as a first radio base station, providing radio coverage over at least one geographical area forming a first cell 11, also referred to herein as the cell 11. Furthermore, the radio communications network comprises another radio network node 13. The other radio network node 13 provides radio coverage over a second geographical area forming a second cell 14. A user equipment 10 is served in the second cell 14 by the other radio network node 13 and is communicating with the other radio network node 13. The user equipment 10 transmits data over a radio interface to the other radio network node 13 in an uplink (UL) transmission and the other radio network node 13 transmits data to the user equipment 10 in a downlink (DL) transmission. The radio communications network may further comprise a third radio network node 15. The third radio network node 15 provides radio coverage over a third geographical area forming a third cell 16. Furthermore, the radio communications network may comprise a positioning node 17 and a Mobility Management Entity (MME) 18 arranged in a core network of the radio communications network.

The positioning node 17 may also be exemplified as a Location Service (LCS) server, Server Mobile Location Centre (SMLC), Secure User Plane Location (SUPL) Location Platform (SLP) or any server enabled to perform positioning of the user equipment 10.

It should be understood that the term “user equipment” is a non-limiting term which means any wireless terminal, device or node e.g. Personal Digital Assistant (PDA), laptop, mobile, mobile tablet, sensor, relay, or even a small base station that are being positioned, e.g. an LCS target in general. The user equipment may also be capable and not capable of performing inter-frequency measurements without gaps, e.g. a user equipment capable of carrier aggregation.

The respective radio network node 12,13,15, which are exemplified in FIG. 1 as radio base stations may further be exemplified as a relay nodes or a beacon nodes. A radio base station may also be referred to as e.g. a NodeB, an evolved Node B (eNB, eNode B), a base transceiver station, Access Point Base Station, base station router, or any other network unit capable to communicate with a user equipment 10 within the cells 11,14,16 depending e.g. of the radio access technology and terminology used. Also, the respective radio network node 12,13,15 may further serve one or more cells.

The user equipment 10 moves towards the radio network node 12 with a velocity v and a handover is performed to the first cell 11 served by the radio network node 12. Thus, the user equipment 10 is then served by the radio network node 12.

According to embodiments herein the user equipment 10 and the radio network node 12 are defined as a radio node, which may alternatively or additionally configure an uplink and/or a downlink signal for use by the user equipment 10 to perform a measurement or for a purpose other than a positioning measurement. Furthermore, the radio node provides the positioning node 17 with configuring information of the configured signals. The positioning node 17 may then request the user equipment 10 to perform timing measurements by using these configured signals. As an example, the radio network node 12 configures one or more UL and/or DL signal for a purpose other than positioning. E.g., a demodulation reference signal (DMRS) and an SRS may be configured for uplink channel estimation and uplink channel dependent scheduling respectively. The UL channel dependent scheduling requires the radio network node 12 to determine an UL channel quality, e.g. UL Signal to Interference plus Noise Ratio (SINR), using SRS sent by the user equipment 10. The SRS may also be configured for tracking an UL timing of the user equipment 10 or retaining or acquiring UL synchronization especially if the user equipment 10 does not transmit data in the uplink. Similarly, a Dedicated Reference Signal (DRS) may be used for downlink scheduling, beamforming, demodulation etc. As the radio node 10,12 informs the positioning node 17 proactively, i.e. the positioning node 17 knows the configuration before requesting the position of the user equipment 10, no delay is introduced as the positioning node 17 knows the configuration.

Thus, at times the radio network node 12 may have to configure user equipments with signals, which can also be used for the timing measurements such as UE Rx−Tx time difference measurement. In this scenario the radio network node 12, i.e. serving eNodeB, indicates with an indication to the positioning node 17 that the necessary signals which can be used for performing UE Rx−Tx time difference measurement are configured for the user equipment 10 or provides the positioning node 17 with the information about the relevant configured signals/channels. The indication may be transmitted upon request from the positioning node 17. The positioning node 17 may also configure the radio network node 12 in the background or proactively. The background or proactive configuration means that the configuration of signals is done even prior to starting the positioning session or positioning measurement. This ensures that the relevant uplink and/or downlink signals are always available when the user equipment 10 is requested to perform a positioning measurement. Additionally or alternatively, the user equipment 10 may also indicate to the positioning node 17 that the necessary signals which can be used for performing UE Rx−Tx time difference measurement are configured by the radio network node 12 or provides the positioning node 17 with the information about the relevant configured signals/channels. The indication may be transmitted upon request from the positioning node 17. The positioning node 17 may also configure the radio network node 12 in the background or proactively. The user equipment 10 may also send such indication whenever there is LPP signaling between the user equipment 10 and positioning node 17 for any other reason e.g. for OTDOA or fingerprinting positioning measurements etc.

The positioning node 17 upon receiving such indication from the radio node, i.e. either from the user equipment 10 or from the radio network node 12, may request the user equipment 10 over LPP to perform the UE Rx−Tx time difference measurement. The positioning node 17 may additionally send a request to the radio network node 12 to further update or modify the configuration of the UL and/or DL signals as described earlier e.g. to update or modify the configuration of a measurement object for, e.g. SRSs, including bandwidth.

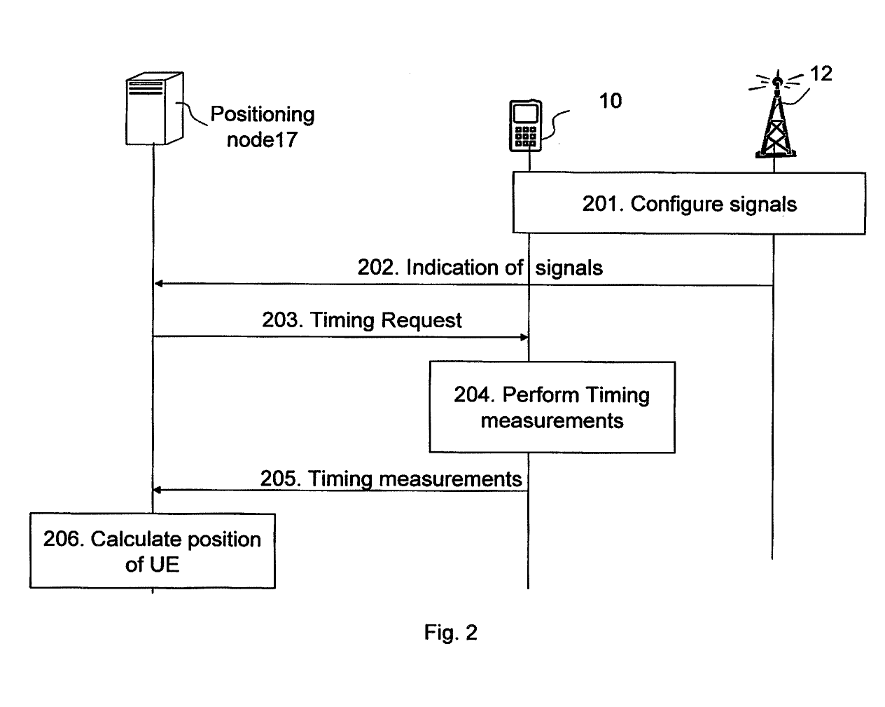

FIG. 2 is a schematic combined flowchart and signalling scheme according to an example of embodiments herein. The actions may be taken in any suitable order.

Action 201. The radio node, illustrated in this example as the radio network node 12, configures uplink and/or downlink signals for e.g. channel estimation, such as SRS or DRS, to perform a channel measurement on e.g. other than a positioning measurement. This may be performed following a received request for the indication.

Action 202. The radio network node 12 then provides an indication that the uplink and/or the downlink signal are configured for use by the user equipment 10 to the positioning node 17. Thus, the positioning node 17 is thereby enabled to use timing measurements of the uplink and/or downlink signals for positioning the user equipment 10. In some embodiments where the radio node is a user equipment 10 the indication may be provided from the user equipment 10.

Action 203. The positioning node 17 then transmits a timing request to the user equipment 10 to use the configured signals. This timing request would typically come transparently via the radio network node 12.

Action 204. The user equipment 10 performs the timing measurements such as UE Rx−Tx time difference measurements on the configured signals.

Action 205. The user equipment 10 then transmits the timing measurements to the positioning node 17. This timing measurement would typically go transparently via the radio network node 12.

Action 206. The positioning node 17 then calculates position of the user equipment 10 using the received timing measurements.

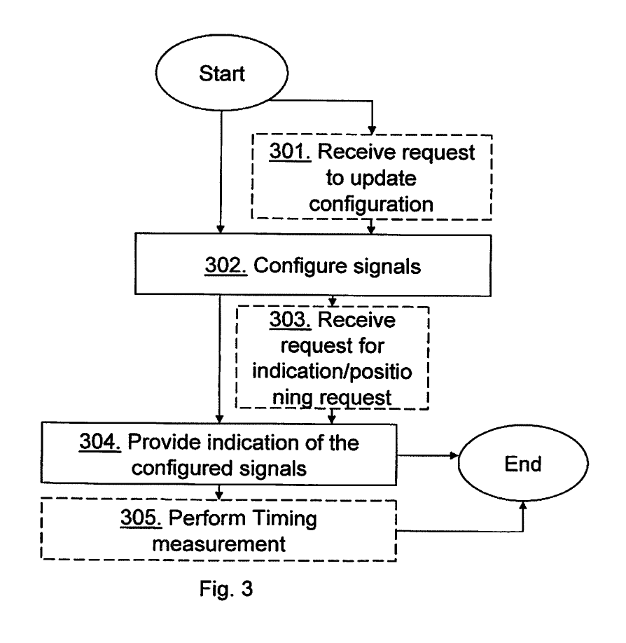

FIG. 3 is a schematic flowchart depicting embodiments of a method in the radio node 10,12 for enabling timing measurement for positioning of the user equipment 10, based on any one or more of: E-CID positioning, AECID positioning, pattern matching, fingerprinting, and hybrid positioning, served in the cell 11 controlled by the radio network node 12. Actions performed in only some embodiments are marked with dashed boxes. The actions do not have to be taken in the order stated below, but may be taken in any suitable order.

Action 301. The radio node may receive a request, from the positioning node 17, to further update or modify the configuring of the uplink and/or downlink signal.

Action 302. The radio node configures the uplink and/or downlink signal for use by the user equipment 10 to perform a measurement or for a purpose other than a positioning measurement. The measurement may be a positioning measurement or a non-positioning measurement. This may be e.g. scheduling.

Action 303. The radio node may in some embodiments receive a request for the indication from the positioning node 17. The radio node may be the user equipment 10 or the radio network node 12. In some embodiments, the radio node receives a positioning request or a request for the timing measurement. This may be received prior or after providing the indication below. Thus, this may act as a trigger to provide the indication.

Action 304. The radio node provides the positioning node 17 with the indication that the uplink and/or the downlink signal are configured for use by the user equipment 10. The positioning node 17 is thereby enabled to use timing measurements of the uplink and/or downlink signal for positioning the user equipment 10. The radio node 10,12 may further provide information about the configured signals. The indication may comprise information about downlink and/or uplink signal configuration. The downlink and/or uplink signal configuration may comprises one or more of: type of uplink signal and/or downlink signal for performing the measurement; bandwidth of uplink signal and/or downlink signal; frequency or component carrier for downlink and/or uplink signals; cell or node identification; time period over which the measurement is done; periodicity of the measurement; Sounding Reference Signal information; and/or measurement gap indication.

The signals may be pre-configured for timing measurement; or signals pre-configured for any other positioning measurement e.g. OTDOA which is also timing measurement. A positioning measurement covers both cases. Timing measurement may be a UE Rx−Tx time difference, but also radio network node Rx−Tx time difference or a TA. That is, all timing measurements requiring UL signals transmission from the user equipment 10. The timing measurement may be any one of: a UE Rx−Tx time difference measurement, a Round Trip Time, RTT, a Timing Advance, and a propagation delay. The uplink signal may be at least one of a Sounding Reference Signal and a Dedicated Reference Signal. The downlink signal may be at least one of a Cell specific Reference Signal, a Dedicated Reference Signal or a Demodulation Reference Signal.

Action 305. In some embodiments the radio node performs the timing measurement. As stated above, this may be performed prior or after the providing of the indication.

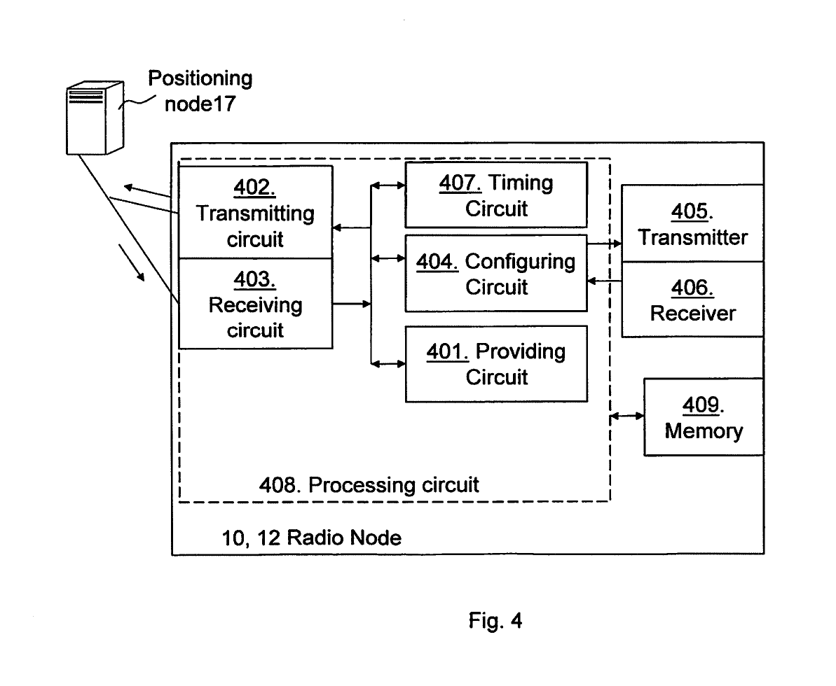

FIG. 4 is a block diagram depicting the radio node 10,12 in accordance with embodiments herein for enabling timing measurement for positioning of the user equipment 10, based on any one or more of: E-CID positioning, AECID positioning, pattern matching, fingerprinting, and hybrid positioning, served in the cell 11 controlled by the radio network node 12.

The radio node, that is, the user equipment 10 or the radio network node 12 comprises a providing circuit 401 configured to provide the positioning node 17 with an indication that an uplink and/or a downlink signal are configured for use by the user equipment 10. The positioning node 17 is thereby enabled to use timing measurements of the uplink and/or downlink signal for positioning the user equipment 10. The indication may comprise information about downlink and/or uplink signal configuration. The downlink and/or uplink signal configuration further comprises one or more of: type of the uplink signal and/or the downlink signal for performing the measurement; bandwidth of the uplink signal and/or the downlink signal; frequency or component carrier for downlink and/or uplink signals; cell or node identification; time period over which the measurement is done; periodicity of the measurement; Sounding Reference Signal information; and/or measurement gap indication. The providing circuit may be connected to a transmitting circuit 402 configured to transmit the information to the positioning node 17.

The radio node may further comprise a receiving circuit 403 configured to receive a request for the indication from the positioning node 17. The receiving circuit 403 may further be configured to receive a request, from the positioning node 17, to further update or modify a configuring of the uplink and/or downlink signal. The receiving circuit 403 may further be configured to receive a positioning request or a request for the timing measurement. This may be received prior or after providing the indication. Thus, this may act as a trigger to provide the indication.

The radio node 10,12 comprises a configuring circuit 404 adapted to configure the uplink and/or downlink signal for use by the user equipment 10 to perform a measurement or for a purpose other than a positioning measurement.

The radio node 10,12 comprises a transmitter 405 that may be configured to be used during the configuration. The configuring circuit 404 may further be connected to a receiver 406 in the radio node. In embodiments where the radio node is a user equipment 10 the transmitter 405 may be comprised in the transmitting circuit 402 and the receiver 406 may be comprised in the receiving circuit 403. The timing measurement may be any one of: a UE Rx−Tx time difference measurement, a Round Trip Time, RTT, a Timing Advance, and a propagation delay. The uplink signal may be at least one of a Sounding Reference Signal and a Dedicated Reference Signal. The downlink signal may be at least one of a Cell specific Reference Signal, a Dedicated Reference Signal or a Demodulation Reference Signal.

In some embodiments the radio node comprises a timing circuit 407 configured to perform the timing measurement.

The embodiments herein for enabling timing measurement for positioning of the user equipment 10 served in the cell 11 controlled by the radio network node 12 may be implemented through one or more processors, such as a processing circuit 408 in the radio node 10,12 depicted in FIG. 4, together with computer program code for performing the functions and/or method steps of the embodiments herein. The program code mentioned above may also be provided as a computer program product, for instance in the form of a data carrier carrying computer program code for performing embodiments herein when being loaded into the radio node 10,12. One such carrier may be in the form of a CD ROM disc. It is however feasible with other data carriers such as a memory stick. The computer program code may furthermore be provided as pure program code on a server and downloaded to the radio node 10,12. Those skilled in the art will also appreciate that the various “circuits” described may refer to a combination of analog and digital circuits, and/or one or more processors configured with software and/or firmware, e.g. stored in memory, that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The radio node 10,12 further comprises a memory 409 that may comprise one or more memory units and may be used to store for example data such as configuration data, indications, timing measurements, applications to perform the methods herein when being executed on the radio node 10,12 or similar.

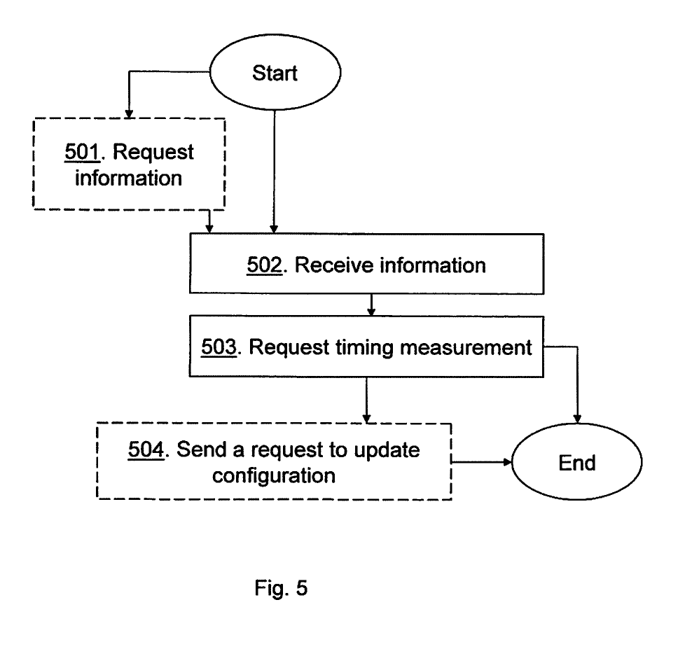

FIG. 5 is a schematic flowchart depicting embodiments of a method in the positioning node 17 for enabling timing measurement for positioning of the user equipment 10, based on any one or more of: E-CID positioning, AECID positioning, pattern matching, fingerprinting, and hybrid positioning, served in the cell 11 controlled by the radio network node 12. Actions performed in only some embodiments are marked with dashed boxes. The actions do not have to be taken in the order stated below, but may be taken in any suitable order.

Action 501. In some embodiments the positioning node 17 requests the information from the user equipment 10 or the radio network node 12.

Action 502. The positioning node 17 receives, from the user equipment 10 or the radio network node 12, above defined as radio node, information that the user equipment 10 in the cell 11 is configured with an uplink and/or a downlink signal for use by the user equipment 10 e.g. for performing a channel measurement. The uplink and/or downlink signal for use by the user equipment 10 is configured to be used to perform a measurement or for a purpose other than a positioning measurement.

Action 503. The positioning node 17 requests the user equipment 10 to perform a timing measurement for positioning of the user equipment 10 using the configured uplink and/or downlink signal.

Action 504. In some embodiments the positioning node 17 sends a request to the radio network node 12, to further update or modify the configuring of the uplink and/or downlink signal. The uplink signal may be at least one of a Sounding Reference Signal and a Dedicated Reference Signal. The downlink signal may be at least one of a Cell specific Reference Signal, a Dedicated Reference Signal or a Demodulation Reference Signal. The timing measurement is any of: a UE Rx−Tx time difference, a radio network node Rx−Tx time difference, a timing advanced or a propagation delay between the user equipment 10 and the radio network node 12.

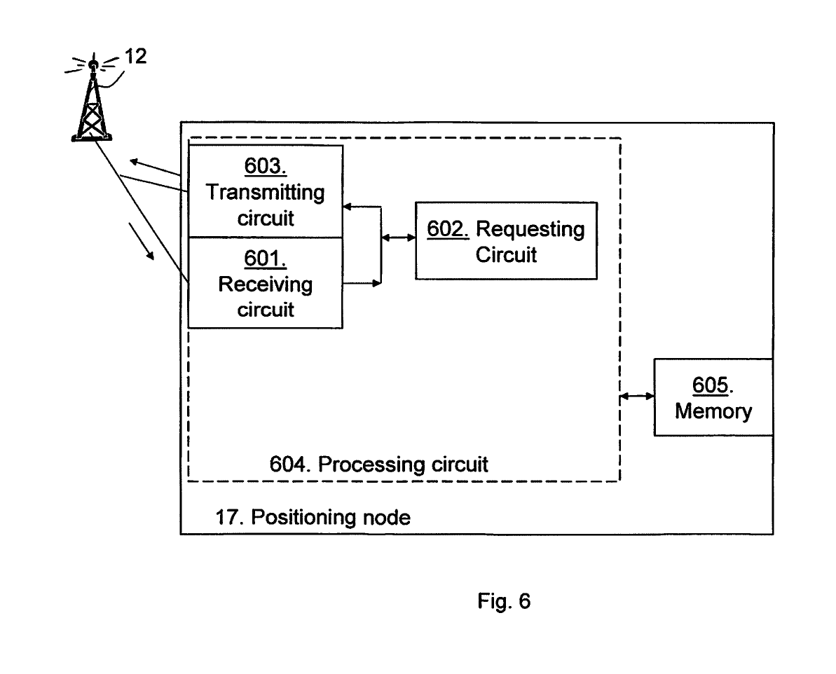

FIG. 6 is a block diagram depicting a positioning node 17 in accordance with embodiments herein for enabling timing measurement for positioning of the user equipment 10 served in the cell 11 controlled by the radio network node 12.

The positioning node 17 comprises a receiving circuit 601 configured to receive, from the user equipment 10 or the radio network node 12, information that the user equipment 10 in the cell 11 is configured with an uplink and/or a downlink signal for use by the user equipment 10. The uplink and/or downlink signal for use by the user equipment 10 is configured to be used to perform a measurement or for a purpose other than a positioning measurement. The positioning node 17 further comprises a requesting circuit 602 configured to request the user equipment 10 to perform a timing measurement for positioning of the user equipment 10 using the configured uplink and/or downlink signal. The requesting circuit 602 may further be configured to request the information from the user equipment 10 or the radio network node 12. In some embodiments the requesting circuit 602 is further configured to request to the radio network node 12, to further update or modify the configuring of the uplink and/or downlink signal. The requesting circuit 602 may be connected to a transmitting circuit 603 arranged in the positioning node 17. As stated above the uplink signal may be at least one of a Sounding Reference Signal and a Dedicated Reference Signal. The downlink signal may be at least one of a Cell specific Reference Signal, a Dedicated Reference Signal or a Demodulation Reference Signal. The timing measurement may be any of: a UE Rx−Tx time difference, a radio network node Rx−Tx time difference, a timing advanced or a propagation delay between the user equipment 10 and the radio network node 12.

The embodiments herein for enabling timing measurement for positioning of the user equipment 10 served in the cell 11 controlled by the radio network node 12 may be implemented through one or more processors, such as a processing circuit 604 in the positioning node 17 depicted in FIG. 6, together with computer program code for performing the functions and/or method steps of the embodiments herein. The program code mentioned above may also be provided as a computer program product, for instance in the form of a data carrier carrying computer program code for performing embodiments herein when being loaded into the positioning node 17. One such carrier may be in the form of a CD ROM disc.

It is however feasible with other data carriers such as a memory stick. The computer program code may furthermore be provided as pure program code on a server and downloaded to the positioning node 17. Those skilled in the art will also appreciate that the various “circuits” described may refer to a combination of analog and digital circuits, and/or one or more processors configured with software and/or firmware, e.g. stored in memory, that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

The positioning node 17 further comprises a memory 605 that may comprise one or more memory units and may be used to store for example data such as configuration data, indications, timing measurements, positions, applications to perform the methods herein when being executed on the positioning node 17 or similar.

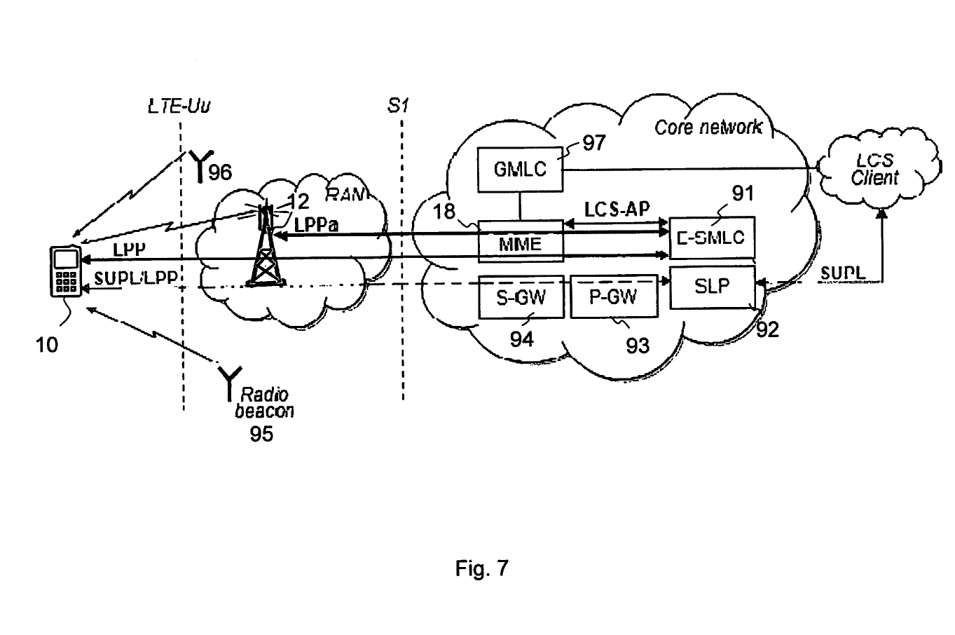

A high-level architecture, as it is currently standardized in LTE, is illustrated in FIG. 7, where an LCS target is the user equipment 10, and an LCS Server is an E-SMLC 91 or an SLP 92. In the figure, the control plane positioning protocols with E-SMLC 91 as the terminating point are shown in dashed arrows, and the user plane positioning protocol is shown in full lined arrows. SLP 92 may comprise two components, SUPL Positioning Centre (SPC) and SUPL Location Centre (SLC), which may also reside in different nodes. In an example implementation, SPC has a proprietary interface with E-SMLC, and LIp interface with SLC, and the SLC part of SLP communicates with a Packet Data Network (PDN)-Gateway (P-GW) 93 and External LCS Client. The P-GW 93 then communicates through a Serving Gateway (S-GW) 94 over the network interface S1 and the air interface LTE-Uu via the radio network node 12.

Additional positioning architecture elements may also be deployed to further enhance performance of specific positioning methods. For example, deploying radio beacons 95,96 is a cost-efficient solution which may significantly improve positioning performance indoors and also outdoors by allowing more accurate positioning, for example, with proximity location techniques.

Also, the signaling described herein is either via direct links, e.g. protocols or physical channels, or logical links e.g. via higher layer protocols and/or via one or more network nodes. For example, in LTE in the case of signaling between E-SMLC and LCS Client the positioning result may be transferred via multiple nodes at least via MME 18 and/or a Gateway Mobile Location Centre (GMLC) 97.

Although the description is mainly given for the user equipment 10, as measuring unit, it should be understood by the skilled in the art that “UE” is a non-limiting term which means any wireless device or node capable of receiving in DL and transmitting in UL e.g. PDA, laptop, mobile, sensor, fixed relay, mobile relay or even a radio base station, e.g. femto base station. The embodiments may therefore apply for non-CA user equipment or both for user equipments capable and not capable of performing inter-frequency measurements without gaps, e.g. also including user equipments capable of carrier aggregation.

The positioning node 17 described in different embodiments is a node with positioning functionality. For example, for LTE it may be understood as a positioning platform in the user plane, e.g., SLP in LTE, or a positioning node in the control plane, e.g. E-SMLC in LTE. SLP may also comprise SPC and SLC, where SPC may also have a proprietary interface with E-SMLC. In a testing environment, at least positioning node may be simulated or emulated by test equipment.

A cell is associated with a radio node, where a radio node or radio network node or eNodeB used interchangeably in the description, comprises in a general sense any node transmitting radio signals used for measurements, e.g., eNodeB, macro/micro/pico base station (BS), home eNodeB, relay, beacon device, or repeater. A radio node herein may comprise a radio node operating in one or more frequencies or frequency bands. It may be a radio node capable of CA. It may also be a single- or multi-RAT node which may e.g. support Multi-Standard Radio (MSR) or may operate in a mixed mode.

The embodiments are not limited to LTE, but may apply with any RAN, single- or multi-RAT. Some other RAT examples are LTE-Advanced, Universal Mobile Telecommunications System (UMTS), High Speed Packet Access (HSPA), GSM, cdma2000, WiMAX, and Wireless Fidelity (WiFi).

Although many embodiments have been discussed for UE Rx−Tx time difference, they may also be applied to other timing user equipment and radio node, e.g. LMU or eNodeB, measurements, e.g. those that require at least UL transmission. The previous embodiments apply to any user equipment or eNodeB timing measurements which require uplink transmitted signals. The positioning node 17 may for example configure the radio network node 12 to measure it over certain measurement bandwidth and requests the radio network node 12/user equipment 10 to use specific DL and/or UL signals. Example of other timing measurement is one way propagation delay, RTT, TA (e.g., Type 1). The timing measurements may also be related to measurements used for UTDOA and other positioning methods, timing adjustment, SON, Minimisation of Drive Tests (MDT), or similar. The timing measurements may be used internally by the user equipment, in its general sense, and/or reported to another node, e.g. the user equipment 10 or radio network node 12 or network node e.g. positioning node 17.

In yet another embodiment, the procedures described herein e.g., configuring or reconfiguring or similat may be associated with or triggered by the event such as the events described in relation to the contention-based random access.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments herein being defined by the following claims.

1.-31. (canceled)

32. A method in a radio node for enabling a timing measurement for positioning of a user equipment, wherein the user equipment is served in a cell controlled by a radio network node, the method comprising:
configuring an uplink and/or a downlink signal for use by the user equipment to perform a measurement or for a purpose other than a positioning measurement;
enabling a positioning node to use timing measurements of the uplink and/or downlink signal for positioning the user equipment by providing the positioning node with an indication that the uplink and/or downlink signal are configured for use by the user equipment.

33. The method of claim 32 wherein the indication comprises information about the downlink and/or uplink signal configuration.

34. The method of claim 33 wherein the downlink and/or uplink signal configuration further comprises one or more of:
a type of the uplink signal and/or downlink signal for performing the measurement;
a bandwidth of the uplink signal and/or downlink signal;
a cell or node identification of the uplink signal and/or downlink signal;
a frequency or component carrier for the downlink and/or uplink signal;
a time period over which the measurement is to be done;
a periodicity of the measurement;
Sounding Reference Signal information;
a measurement gap indication.

35. The method according claim 32 further comprising receiving a request for the indication from the positioning node.

36. The method of claim 32 further comprising receiving a request, from the positioning node, to update or modify the configuring of the uplink and/or downlink signal.

37. The method of claim 32 wherein the radio node is the user equipment.

38. The method of claim 32 wherein the radio node is the radio network node.

39. The method of claim 38 wherein the timing measurement is any one of:
a User Equipment Receiving-Transmitting time difference measurement;
a Round Trip Time;
a Timing Advance;
a propagation delay.

40. The method of claim 32 wherein the uplink signal is at least one of:
a Sounding Reference Signal;
a Dedicated Reference Signal.

41. The method of claim 32 wherein the downlink signal is at least one of:
a Cell specific Reference Signal;
a Dedicated Reference Signal;
a Demodulation Reference Signal.

42. The method of claim 32 further comprising
receiving a positioning request or a request for the timing measurement;
performing the timing measurement.

43. A method in a positioning node for enabling a timing measurement for positioning of a user equipment served in a cell controlled by a radio network node, the method comprising:
receiving, from the user equipment or the radio network node, information that the user equipment in the cell is configured with an uplink and/or a downlink signal for use by the user equipment;
requesting the user equipment to perform a timing measurement for positioning the user equipment using the configured uplink and/or downlink signal.

44. The method of claim 43 wherein the uplink and/or downlink signal for use by the user equipment is configured to be used to perform a measurement or for a purpose other than a positioning measurement.

45. The method of claim 43 further comprising sending a request to the radio network node, to further update or modify the configuring of the uplink and/or downlink signal.

46. The method of claim 43 wherein the uplink signal is at least one of:
a Sounding Reference Signal;
a Dedicated Reference Signal.

47. The method of claim 43 wherein the downlink signal is at least one of:
a Cell specific Reference Signal;
a Dedicated Reference Signal;
a Demodulation Reference Signal.

48. The method of claim 43 wherein the timing measurement is any of:
a User Equipment Receiving-Transmitting time difference;
a radio network node Receiving-Transmitting time difference;
a Timing Advance;
a propagation delay between the user equipment and the radio network node.

49. A radio node for enabling timing measurement for positioning of a user equipment served in a cell controlled by a radio network node, the radio node comprising:
a configuring circuit adapted to configure an uplink and/or downlink signal for use by the user equipment to perform a measurement or for a purpose other than a positioning measurement;
a providing circuit configured to enable a positioning node to use timing measurements of the uplink and/or downlink signal for positioning the user equipment by providing the positioning node with an indication that the uplink and/or the downlink signal are configured for use by the user equipment.

50. The radio node of claim 49 wherein the indication comprises information about downlink and/or uplink signal configuration.

51. The radio node of claim 50 wherein the downlink and/or uplink signal configuration further comprises one or more of:
a type of uplink signal and/or downlink signal for performing the measurement;
a bandwidth of uplink signal and/or downlink signal;
a frequency or component carrier for downlink and/or uplink signals;
a cell or node identification;
a time period over which the measurement is to be done;
a periodicity of the measurement;
Sounding Reference Signal information;
a measurement gap indication.

52. The radio node of claim 49 further comprising a receiving circuit configured to receive a request for the indication from the positioning node.

53. The radio node of claim 49 wherein the receiving circuit is further configured to receive a request, from the positioning node, to further update or modify a configuring of the uplink and/or downlink signal.

54. The radio node of claim 49 wherein the radio node is the user equipment.

55. The radio node of claim 49 wherein the radio node is the radio network node.

56. The radio node of claim 49 wherein the timing measurement is any one of:
a User Equipment Receiving-Transmitting time difference measurement,
a Round Trip Time;
a Timing Advance;
a propagation delay.

57. The radio node of claim 49 wherein the uplink signal is at least one of:
a Sounding Reference Signal;
a Dedicated Reference Signal.

58. The radio node of claim 49 wherein the downlink signal is at least one of
a Cell specific Reference Signal;
a Dedicated Reference Signal;
a Demodulation Reference Signal.

59. The radio node of claim 49 further comprising:
a receiving circuit configured to receive a positioning request or a request for the timing measurement;
a timing circuit configured to perform the timing measurement.

60. A positioning node for enabling timing measurement for positioning of a user equipment served in a cell controlled by a radio network node, the positioning node comprising:
a receiving circuit configured to receive, from the user equipment or the radio network node, information that the user equipment in the cell is configured with an uplink and/or a downlink signal for use by the user equipment;
a requesting circuit configured to request the user equipment to perform a timing measurement for positioning the user equipment using the configured uplink and/or downlink signal.

61. The positioning node of claim 60 wherein the uplink and/or downlink signal for use by the user equipment is configured to be used to perform a measurement or for a purpose other than a positioning measurement.

62. The positioning node of claim 60 wherein the requesting circuit is further configured to request the information from the user equipment or the radio network node.

63. The positioning node of claim 60 wherein the requesting circuit is further configured to request the radio network node to further update or modify the configuring of the uplink and/or downlink signal.

64. The positioning node of claim 60 wherein the uplink signal is at least one of:
a Sounding Reference Signal;
a Dedicated Reference Signal.

65. The positioning node of claim 60 wherein the downlink signal is at least one of:
a Cell specific Reference Signal
a Demodulation Reference Signal.

66. The positioning node of claim 60 wherein the timing measurement is any one of:
a User Equipment Receiving-Transmitting time difference;
a radio network node Receiving-Transmitting time difference;
a timing advance;
a propagation delay between the user equipment and the radio network node.
